(19) United States
(12) Patent Application Publication
(10) Pub. No.: US 2008/0178641 A1
(43) Pub. Date: Jul. 31, 2008

(54) Device and method for locking apparatuses

(76) Inventor: Hans-Rudolf Himmen, Haimhausen (DE)

Correspondence Address: The BOC Group, Inc., 575 MOUNTAIN AVENUE, MURRAY HILL, NJ, 07974-2082, US

(21) Appl. No.: 11/985,274

(22) Filed: Nov. 14, 2007

(30) Foreign Application Priority Data
Dec. 22, 2006 (DE) 102006061072.5

(51) Int. Cl. E05B 65/00

(52) U.S. Cl. 70/57; 70/262

(57) ABSTRACT

The present invention relates to a system for locking apparatuses having a profile frame for receiving at least one apparatus. Furthermore, the present invention relates to a device for receiving one or more apparatuses, which has a profile frame, as well as a modified apparatus foot and a method for locking. The system according to the present invention is characterized in that the apparatus has apparatus feet modified for the engagement of a locking hook and the profile frame has at least one receptacle and at least one locking hook and one unlocking slider for each apparatus foot to be received, no screw connection parts used for locking the apparatus being provided.

### CROSS REFERENCE TO RELATED APPLICATIONS

This application claims priority from German Patent Application Serial No. 102006061072.5, filed Dec. 22, 2006.

### BACKGROUND OF THE INVENTION

The present invention relates to a system for locking apparatuses having a profile frame for receiving at least one apparatus. Furthermore, the present invention relates to a device for receiving one or more apparatuses, which has a profile frame, as well as a modified apparatus foot and a method for locking.

A facility according to the method frequently has a frame stand, in which one or more apparatuses are introduced as components of the facility and screwed in place therein. The components of the facility may be, for example, heat exchangers, electric heaters, or containers together with valves and components of measurement and regulatory technology, as well as piping.

The apparatuses are typically connected to the frame stand using screw connections. The apparatus feet are connected to the frame stand using four or more screws and nuts.

There is an entire array of uses, e.g., in experimental or pilot facilities, in which apparatuses must be replaced frequently. This is always the case if one apparatus is to be replaced by an apparatus of another type or having different performance data.

Depending on the compactness of the facility and the space conditions in and around the frame stand, the typically used screw connections between the apparatus feet and the frame stand are only accessible with difficulty or are also sometimes only accessible after removing other facility parts. The effort for replacing and fastening other apparatuses in the facility may accordingly be high.

### BRIEF SUMMARY OF THE INVENTION

The object of the present invention is to improve the locking of apparatuses in a frame stand and, in particular, to reduce the effort when replacing apparatuses.

The stated object is achieved by a system which is characterized in that the apparatus has modified apparatus feet for the engagement of a locking hook and the profile frame has at least one receptacle and at least one locking hook and one unlocking slider for each apparatus foot to be received, no screw connection parts used for locking the apparatus being provided.

The profile frame preferably has a U-profile.

Two locking hooks are especially preferably provided per apparatus foot to be locked.

The locking hooks are expediently fastened on the profile frame so they are rotatable. For example, they are advantageously fastened to the profile frame at their bottom end.

The locking hooks are especially advantageously fastened between transverse struts in the profile frame.

According to an advantageous refinement of the present invention, one restoring unit is provided on each locking hook. Depending on the application, for example, a restoring spring, a threaded rod, or a gear rack is advantageously used as the restoring unit.

The restoring unit is advantageously implemented in such a way that it holds the locking hook in a vertical position.

The unlocking slider is expediently attached in the profile frame so it is displaceable in at least one direction.

According to an especially advantageous design of the present invention, the apparatus foot has a catch trough or opening, which allows catching of the locking hook.

Furthermore, the stated object of the present invention is achieved by a device which is characterized in that the profile frame has at least one receptacle and at least one locking hook and one unlocking slider for each apparatus foot to be received, no screw connection parts used for locking the apparatus being provided.

Furthermore, the stated object is achieved by an apparatus foot, which is characterized in that the apparatus foot is implemented as modified for the engagement of a locking hook.

The apparatus foot preferably has a catch trough or opening which allows catching of the locking hook.

The stated object is achieved in regard to the method in that locking hooks are pressed to the side by the apparatus foot when the apparatus is inserted into the receptacle and, as soon as the apparatus is located at its final position, the locking hooks are each drawn back into their original position by a restoring unit, by which the particular apparatus foot is locked.

The present invention has an array of advantages:

Simple and rapid replacement of apparatuses is made possible. Screw connections, which are difficult to access and complex to loosen and fasten, may be dispensed with.

The apparatus to be changed may be placed easily in the frame stand using a forklift, for example, and locked therein automatically or using a few simple manual actions. The disengagement of the locking may also be performed easily. The construction of the system according to the present invention and its components is simple, robust, nearly maintenance-free, and usable in manifold ways.

The present invention and further designs of the present invention are explained in greater detail in the following on the basis of the exemplary embodiments illustrated in the figures.

### BRIEF DESCRIPTION OF THE DRAWINGS

FIG. 1 shows a side view of a system according to the present invention.

FIG. 2 shows a top view of the system from FIG. 1.

FIG. 3 shows a frontal view of a system according to the present invention having modified restoring unit (trapezoidal thread).

FIG. 4 shows a frontal view of a system according to the present invention having modified restoring unit (gear rack).

### DETAILED DESCRIPTION OF THE INVENTION

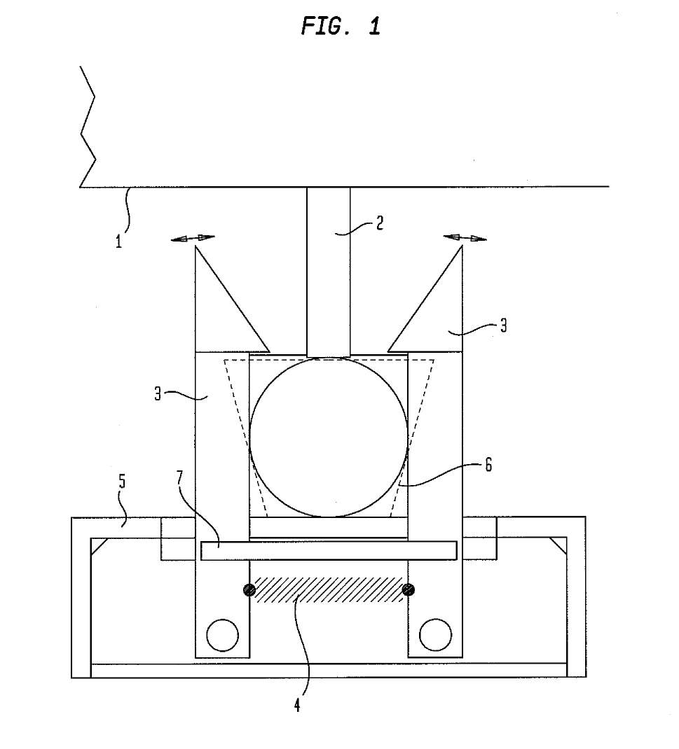

In FIG. 1, an apparatus 1 is shown as a detail, which rests on an apparatus foot 2. The apparatus foot 2 is locked by the locking hooks 3, which are in turn held in this position by the restoring unit 4. The apparatus foot 2 is received by so-called receptacles 6, which are fastened to the profile frame 5. The receptacles 6 are implemented in this example as receptacle corners 6. An unlocking slider 7 is available to disengage the locking. In this example, a restoring spring 4 is provided as the restoring unit 4.

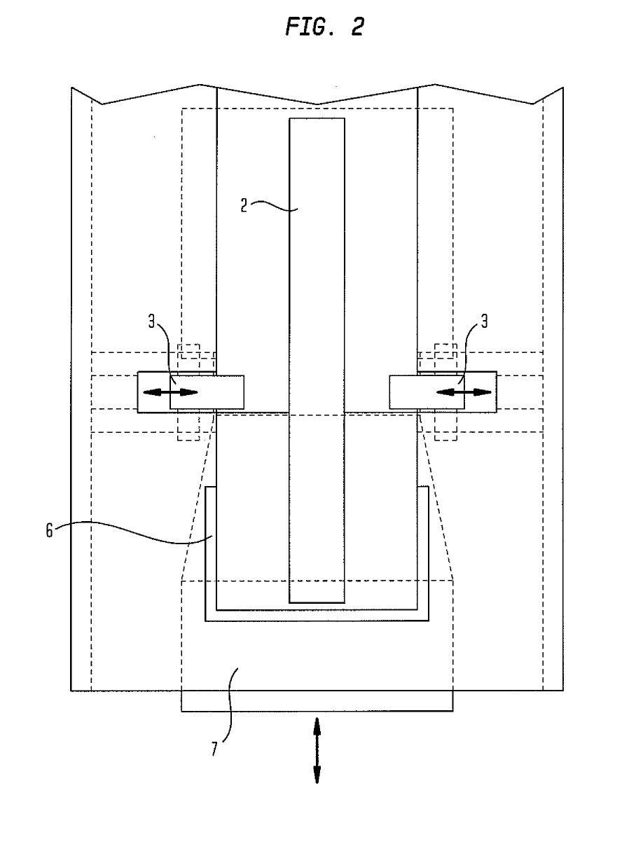

FIG. 2 shows a top view of the system according to the present invention, which is shown in FIG. 1 as a side view. The individual parts of the system are identified using the reference numerals from FIG. 1.

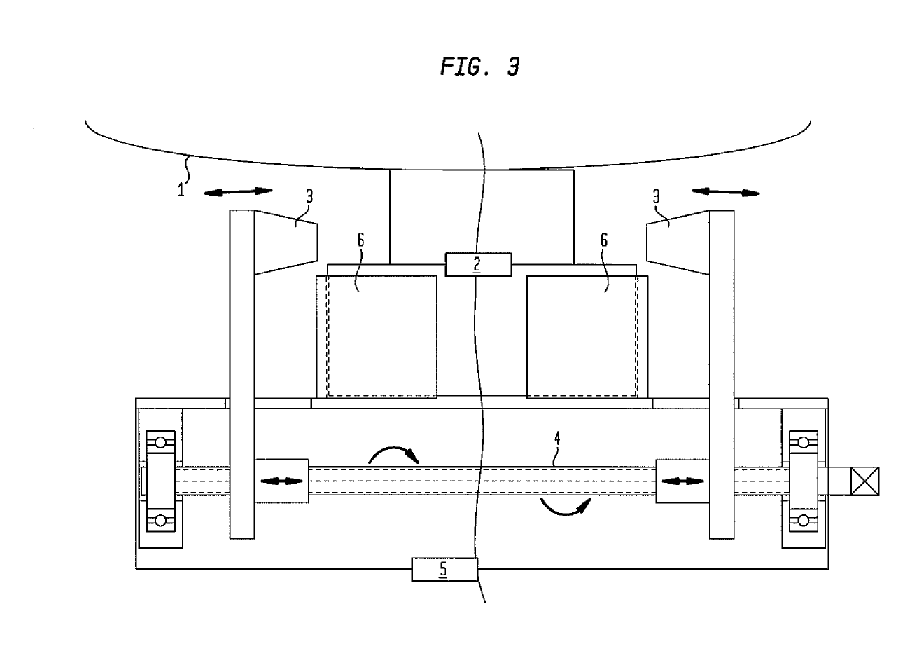

FIG. 3 shows a frontal view of a system according to the present invention having a modified restoring unit 4. The restoring unit 4 is implemented in this example as a trapezoidal thread 4 (½ right-handed, ½ left-handed thread). The remaining parts of the illustrated system correspond to those in FIGS. 1 and 2 and bear the corresponding reference numerals.

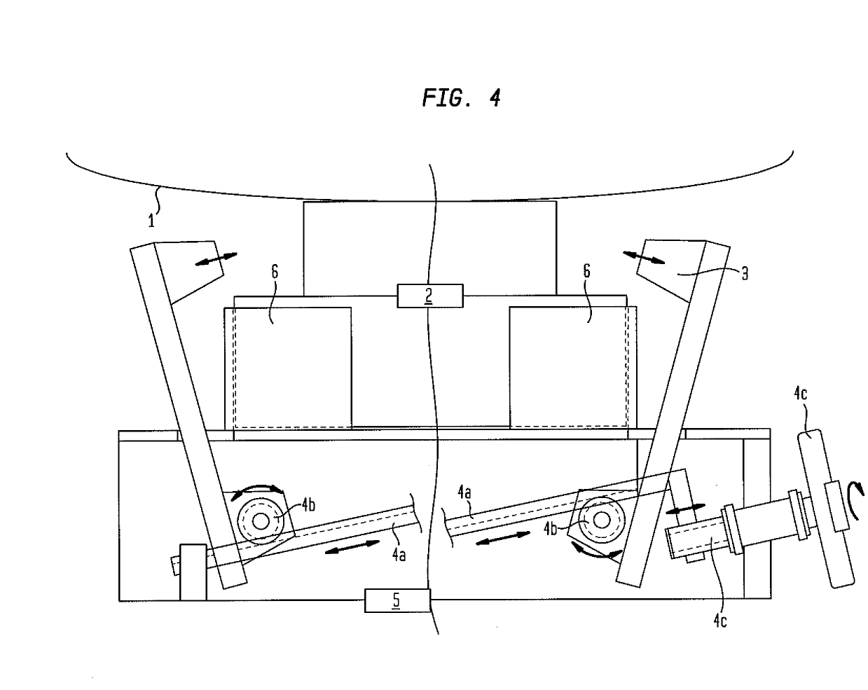

FIG. 4 shows a further frontal view of a system according to the present invention having a further alternative achievement of the object for the restoring unit 4. In this example, a restoring unit 4, which has a gear rack 4a and gearwheels 4b as well as an adjustment wheel 4c having threaded pins, is used. The remaining parts of the illustrated system again correspond to those in FIGS. 1, 2, and 3 and bear the corresponding reference numerals.

The mode of operation of the system illustrated in FIGS. 1 and 2 is as follows: the apparatus 1, e.g., a heat exchanger 1 or another apparatus 1, is placed from above in the receptacle 6 using a forklift, for example. When the heat exchanger feet 2 are lowered, the locking hooks 3 are pressed to the side. As soon as the heat exchanger foot 2 is located in its final position in the receptacles 6, the locking hooks 3 are drawn by the restoring spring 4 back into a vertical position and thus lock the heat exchanger foot 2 on top. The receptacles 6 are designed in such a way that the heat exchanger 1 is also fixed axially and transversely to its axis. Therefore, together with the locking hooks 3, a solid connection to the profile frame 5 thus results.

For the case in which this connection is to be disengaged, the unlocking slider 7 is displaced laterally in such a way that, because of its profile (cf. FIG. 2), it presses the locking hooks 3 apart enough that they release the heat exchanger feet 2 and the heat exchanger 1 may be lifted out of the profile frame 5. The unlocking slider 7 is advantageously guided inside the U-profile of the profile frame 5 by corresponding through openings in the transverse struts (not shown) and may be moved back into its starting position by spring force.

The following statements are used as an example of an advantageous embodiment of a system according to the present invention. Manifold designs which are just as advantageous, having other dimensions and other forms, also exist.

As an example, a U-profile having 400×120×50 mm (length×width×height) as a profile frame 5, a rotatable fastening of the locking hooks 3 using bolts or screws having a diameter of 6-8 mm between two transverse struts inside the U-profile 5, and a restoring spring 4 as a tensile spring having a hook eye, inter alia, and a length of approximately 50 mm and a diameter of approximately 6-8 mm may be provided.

Furthermore, in this example receptacles 6 made of flat steel, which are bent in a trapezoid or V-shape (rounded), laterally closed, and welded onto the profile frame 5 may be used.

Two locking points per apparatus foot 2 having two receptacles 6, two locking hooks 3 each, and one unlocking slider 7 are specified as an example of an especially advantageous design.

A pipe having a diameter of approximately 40 mm and a length of approximately 350 mm having receptacles 6 welded on top in the area of the locking hooks 3 is used as an example of an especially suitable apparatus foot 2.

FIG. 3 shows a similar construction in regard to the profile frame 5, the apparatus feet 2, and the receptacles 6. However, the locking hooks 3 are moved from the side via the apparatus foot 2 when the apparatus is introduced into the profile frame 5 in this example. This is performed by a double-threaded trapezoidal thread 4 mounted in the profile frame 5, on which the locking hooks 3 may be moved together or apart axially by rotation (on the part of the operator). The locking hooks 3 are guided upward by corresponding through openings in the profile frame 5. They are thus also prevented from rotating.

FIG. 4 again shows a similar construction in regard to the profile frame 5, the apparatus feet 2, and the receptacles 6, but the locking hooks 3 are tilted via the apparatus foot 2 from the side. This is performed by a gear rack 4a (½ toothed on top, ½ toothed on the bottom), which engages on one side from above in a gearwheel 4b connected fixed to the locking hook 3, and from below on the other side. The locking hooks 3 are fastened in the profile frame 5 so they are rotatable. The axial movement of the gear rack 4a occurs due to an adjustment wheel 4c having threaded pins. The latter is seated in an adapter (having threaded hole) connected to the gear rack 4a. The guide of the gear rack 4a is implemented inside the U-profile of the profile frame 5.

What we claim is:

1. A system for locking apparatuses having a profile frame for receiving at least one apparatus, characterized in that the apparatus has apparatus feet modified for the engagement of a locking hook and the profile frame has at least one receptacle and at least one locking hook and one unlocking slider for each apparatus foot to be received, no screw connection parts used for locking the apparatus being provided.

2. A device for receiving one or more apparatuses, which has a profile frame, characterized in that the profile frame has at least one receptacle and at least one locking hook and one unlocking slider for each apparatus foot to be received, no screw connection parts used for locking the apparatus being provided.

3. The device according to claim 2, characterized in that the profile frame has a U-profile.

4. The device according to claim 2, characterized in that at least two, in particular four locking hooks are provided per apparatus foot to be locked.

5. The device according to claim 2, characterized in that the locking hooks are fastened to the profile frame so they are rotatable.

6. The device according to claim 2, characterized in that the locking hooks are fastened between transverse struts in the profile frame.

7. The device according to claim 2, characterized in that a restoring unit is provided on each locking hook.

8. The device according to claim 7, characterized in that the restoring unit is implemented in such a way that it holds the locking hook in a vertical position.

9. The device according to claim 2, characterized in that the unlocking slider is attached in the profile frame so it is displaceable in at least one direction.

10. An apparatus foot, characterized in that the apparatus foot is implemented as modified for the engagement of a locking hook.

11. The apparatus foot according to claim 10, characterized in that the apparatus foot has a catch trough or opening which allows catching of the locking hook.

12. A method for locking apparatuses, in which at least one apparatus is placed in receptacles provided for this purpose on a profile frame, characterized in that locking hooks are pressed to the side by the apparatus feet when the apparatus is placed in the receptacles, and, as soon as the apparatus is located at its final position, the locking hooks are each drawn by a restoring unit back into their original position, by which the particular apparatus foot is locked.
